(19) United States
(12) Patent Application Publication
(10) Pub. No.: US 2020/0409024 A1
(43) Pub. Date: Dec. 31, 2020

(54) LENS MODULE AND ELECTRONIC DEVICE

(71) Applicant: AAC Optics Solutions Pte. Ltd., Singapore city (SG)

(72) Inventor: Lingyun Xu, Shenzhen (CN)

(21) Appl. No.: 16/914,354

(22) Filed: Jun. 27, 2020

(30) Foreign Application Priority Data
Jun. 28, 2019 (CN) PCT/CN2019/093636

(51) Int. Cl. G02B 7/02; G02B 7/04; H04N 5/225

(52) U.S. Cl. CPC G02B 7/026; H04N 5/2254; G02B 7/04; G02B 7/021

(57) ABSTRACT

A lens module includes a lens barrel, a lens group and a press ring, the lens barrel defines a light-through hole and a receiving cavity in communication with the light-through hole, the lens group and the press ring are sequentially arranged in the receiving cavity along a direction from the light-through hole towards the receiving cavity, the press ring includes opposite upper and lower ring surfaces, and an outer wall surface connected to outer ring edges of the upper and lower ring surfaces, the outer wall surface abuts against the lens barrel, the upper ring surface abuts against the lens group, a leakage gap is defined between the lens barrel and a connecting surface of the lens adjacent to the press ring, and an exhaust groove in communication with the leakage gap and external space is provided on the upper ring surface. An electronic device includes the lens module.

### TECHNICAL FIELD

The present invention relates to the field of optical technology and, in particular, to a lens module and an electronic device.

### BACKGROUND

With the gradual maturity of optical imaging technology, various imaging products such as cameras, video cameras, telescopes, etc. have also been widely used, and designs of lens modules have always been a key consideration for manufacturers of such products. At present, the lens module generally includes a lens barrel, a lens group and a press ring, and the press ring usually abuts against the lens group to tightly press the lens group into a receiving cavity of the lens barrel.

However, due to structural limitations, the existing press ring, lens, and lens barrel usually together define a closed gas environment. That is, air inside the lens barrel cannot communicate with the atmosphere, which makes it difficult to dissipate heat inside the lens, resulting in relatively high temperature and humidity, and affecting an overall performance of the lens module.

Therefore, it is necessary to provide a new lens module to solve the above technical problems.

### SUMMARY

An object of the present invention is to provide a lens module to solve the technical problem of difficulties in heat dissipation inside the lens barrel of the current lens module.

The technical solutions of the present invention are as follows:

A lens module is provided. The lens module includes: a lens barrel, the lens barrel defining a light-through hole and a receiving cavity in communication with the light-through hole; a lens group including at least two lenses stacked along a direction of a centerline of the light-through hole; and a press ring including an upper ring surface and a lower ring surface that are opposite to each other in a direction parallel to the centerline of the light-through hole, and an outer wall surface connected to an outer ring edge of the upper ring surface and an outer ring edge of the lower ring surface. Each of the at least two lenses includes an optical portion and an extending portion surrounding the optical portion, and the extending portion includes a connecting surface that abuts against and fits the lens barrel. The lens group and the press ring are sequentially arranged in the receiving cavity along a direction from the light-through hole towards the receiving cavity, the outer wall surface abuts against an inner wall of the lens barrel, and the upper ring surface abuts against the lens group. A leakage gap is defined between the lens barrel and the connecting surface of one of the at least two lenses that is adjacent to the press ring, and an exhaust groove is provided on the upper ring surface, and the exhaust groove is in communication with the leakage gap.

In an embodiment, a plurality of the exhaust grooves is provided.

In an embodiment, the plurality of exhaust grooves is evenly distributed on the upper ring surface around the centerline of the light-through hole.

In an embodiment, an extending direction of the exhaust groove is parallel to a radial direction of the light-through hole.

In an embodiment, the press ring further includes an inner wall surface, the inner wall surface includes a first ring surface and a second ring surface that are connected to each other, the first ring surface is connected to an inner ring edge of the upper ring surface, the second ring surface is connected to an inner ring edge of the lower ring surface, and an acute angle is formed between the first ring surface and the second ring surface.

In an embodiment, the optical portion includes an object side surface and an image side surface that are opposite to each other, the extending portion further includes a first extending surface and a second extending surface that are opposite to each other, the first extending surface extends from the object side surface in a direction facing away from an optical axis, the second extending surface extends from the image side surface in a direction facing away from the optical axis, and the connecting surface connects the first extending surface with the second extending surface; and the upper ring surface abuts against the second extending surface that is farthest from the light-through hole among second extending surfaces of extending portions of the at least two lenses.

In an embodiment, a gate slot is provided on the connecting surface, and the leakage gap includes the gate slot.

In an embodiment, the lens module further includes a light-shielding plate located between two adjacent lenses of the at least two lenses and abutting against and fitting the two adjacent lenses.

In an embodiment, the light-shielding plate further abuts against and fits the lens barrel.

The present invention provides an electronic device, and the electronic device includes the lens module described above.

The lens module provided by the present invention includes at least the following beneficial effects: by providing the exhaust groove on the outer wall surface of the press ring and allowing the leakage gap to effectively communicate with the external space through the exhaust groove, the leakage gap can exchange air with the external space to facilitate heat dissipation of the lens module, such that the temperature and humidity in the lens barrel is more reliable and controllable, thereby improving the overall performance and service life of the lens module; in addition, since the leakage gap is in communication with the atmosphere, during installation of the press ring, the press ring is no longer affected by a pressure difference between an air pressure in the leakage gap and the atmosphere, which provides a more convenient assembling process, in turn optimizes matching accuracy of the press ring and the lens barrel and improves stability of a back focus of the lens module.

The electronic device provided by the present invention includes the above lens module and thus has all the beneficial effects of the lens module due, which will not be repeated here.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present invention. Moreover, in the drawings, like reference numerals designate corresponding parts throughout the several views.

FIG. 1 is a cross-sectional structural schematic diagram of a lens module provided by the present invention;

FIG. 2 is an exploded structural schematic diagram of the lens module in FIG. 1; and

FIG. 3 is a structural schematic diagram of a press ring used in a lens module provided by the present invention.

### DESCRIPTION OF EMBODIMENTS

The present invention will be further described below with reference to the drawings and embodiments.

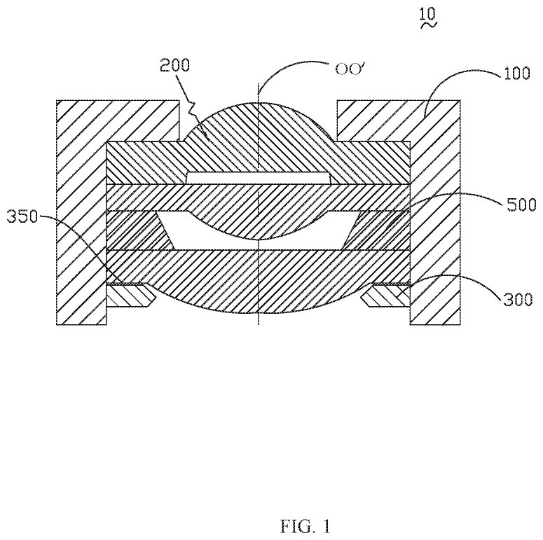

Referring to FIG. 1 to FIG. 3, the present invention discloses a lens module 10 including a lens barrel 100, a press ring 300 and a lens group 200. The lens barrel 100 defines a light-through hole 110 and a receiving cavity 120 in communication with the light-through hole 110. The lens group 200 and the press ring 300 are sequentially arranged in the receiving cavity 120 along a direction from the light-through hole 110 towards the receiving cavity 120.

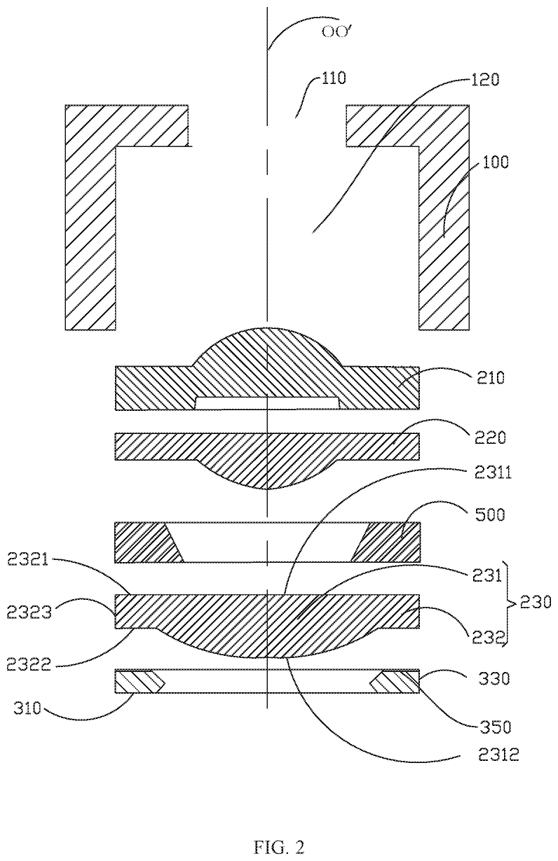

Referring to FIG. 1, the lens group 200 includes a plurality of lenses, and the plurality of lenses is stacked on each other along an extending direction of a centerline 00′ of the light-through hole 110, and the press ring 300 abuts against one lens of the plurality of lenses that is farthest from the light-through hole 110. For example, in this embodiment, referring to FIGS. 1 and 2 again, the lens group 200 includes three lenses, which are referred to herein as a first lens 210, a second lens 220, and a third lens 230 for convenience of description. The first lens 210, the second lens 220, and the third lens 230 are sequentially arranged along the direction from the light-through hole 110 towards the receiving cavity 120, and the press ring 300 abuts against the third lens 230.

In an embodiment, each of the lenses includes an optical portion, and an extending portion surrounding the optical portion.

Taking the third lens 230 for example, the third lens 230 includes an optical portion 231 and an extending portion 232. The optical portion 231 has an optical axis, and the optical axis coincides with the centerline 00′ of the light-through hole 110. The optical portion 231 includes an object side surface 2311 and an image side surface 2312 that is opposite to the object side surface 2311. The extending portion 232 includes a connecting surface 2323, and a first extending surface 2321 and a second extending surface 2322 that are oppositely arranged and parallel to each other. The first extending surface 2321 extends from the object side surface 2311 in a direction away from the optical axis, and the second extending surface 2322 extends from the image side surface 2312 in a direction away from the optical axis. The connecting surface 2323 connects the first extending surface 2321 with the second extending surface 2322 and abuts against and fits an inner wall of the lens barrel 100 that defines the receiving cavity 120. The press ring 300 abuts against the second extending surface 2322 of the third lens 230.

Further, a leakage gap (not shown) is defined between the connecting surface 2323 of the third lens 230 and the lens barrel 100.

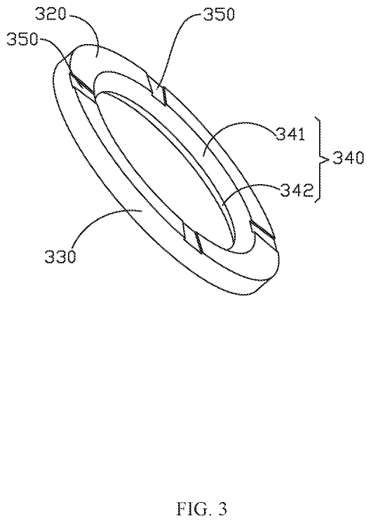

Referring to FIGS. 2 and 3, the press ring 300 includes an upper ring surface 310, a lower ring surface 320 and an outer wall surface 330, the upper ring surface 310 and the lower ring surface 320 are oppositely arranged in a direction parallel to the centerline 00′, the upper ring surface 310 abuts against and fits the second extending surface of the third lens 230, and the outer wall surface 330 is connected to an outer ring edge of the upper ring surface 310 and an outer ring edge of the lower ring surface 320 and abuts against and fits the inner wall of the lens barrel 100 that defines the receiving cavity 120. In particular, an exhaust groove 350 is provided at the upper ring surface 310, and the exhaust groove 350 is in communication with the leakage gap and external space.

In this way, the exhaust groove 350 provided at the upper ring surface 310 of the press ring 300 enables the leakage gap to effectively communicate with the external space through the exhaust groove 350, so that the leakage gap can exchange air with the external space to facilitate heat dissipation of the lens module 10. Therefore, the temperature and humidity in the lens barrel 100 is more reliable and controllable, and the overall performance and service life of the lens module 10 are improved. In addition, since the leakage gap is in communication with the atmosphere, during installation of the press ring 300, the press ring 300 is no longer affected by a pressure difference between an air pressure in the leak gap and the atmospheric pressure, providing a more convenient assembly process, optimizing matching accuracy of the press ring 300 and the lens barrel 100, and improving stability of a back focus of the lens module 10.

It can be understood that, the leakage gap may be in communication with gaps between the respective lenses and in communication with gaps between the respective lenses and the lens barrel 100, so that the heat dissipation performance of the lens module 10 can be optimized more effectively.

It is worth mentioning that, due to addition of the exhaust groove 350, the press ring 300 can be structured more simply, so as to reduce processing difficulties of the press ring 300. Therefore, the lens module 10 provided by the present invention also has advantages of a simplified structure, reduced costs, and reduced forming difficulties of the press ring 300.

In other embodiments of the present invention, more or less lenses may be provided according to actual needs, which is not limited here. In addition, specific shapes of the optical portion 231 and the extending portion 232 of the respective lenses may be the same or different, which should be determined according to actual needs.

In an embodiment, referring to FIG. 3, the press ring 300 further includes an upper wall surface 340, and the inner wall surface 340 connects an inner ring edge of the upper ring surface 310 and an inner ring edge of the lower ring surface 320. For example, the inner wall surface 340 includes a first ring surface 341 and a second ring surface 342 that are connected to each other, the first ring surface 341 is connected to the inner ring edge of the upper ring surface 310, the second ring surface 342 is connected to the inner ring edge of the lower ring surface 320, and an acute angle is formed between the first ring surface 341 and the second ring surface 342. Specific shape and size of the inner wall surface 340 are configured to adapt to the structure of the lens group 200, which is not limited herein.

In an embodiment, a plurality of exhaust grooves 350 is provided. In this way, an air exchange rate between the leakage gap and the external space can be increased, which helps to enhance the heat dissipation effect, improve the reliability of the temperature and humidity in the lens barrel 100, and further improve the assembling accuracy of the press ring 300 and the lens barrel 100.

In an embodiment, four exhaust grooves 350 are provided.

In an embodiment, a plurality of exhaust grooves 350 is evenly distributed at the upper ring surface 310 around the centerline 00′ of the light-through hole 110. In this way, the leakage gap has a more uniform air pressure distribution at various positions, which further improves the heat dissipation performance of the lens barrel 100 and effectively improves the assembling accuracy of the press ring 300 and the lens barrel 100. In addition, a structure of a forming die required for the structure in which the plurality of exhaust grooves 350 is evenly distributed around the centerline 00′ of the light-through hole 110 is simple, so that forming cost of the press ring 300 can be lowered.

In an embodiment, referring to FIG. 3, an extending direction of the exhaust groove 350 is parallel to a radial direction of the light-through hole 110.

In an embodiment, a gate slot (not shown) is provided on the connecting surface 2323 of each of the respective lenses, and the leakage gap includes the gate slot. That is, the gate slot may be the leakage gap or a part of the leakage gap, and the exhaust groove can exchange air with the gate slot.

In an embodiment, referring to FIGS. 1 and 2, the lens module 10 further includes a light-shielding plate 500. The light-shielding plate 500 is located between two adjacent lenses and abuts against and fits the extending portions 232 of the two lenses. The addition of the light-shielding plate 500 can effectively reduce stray light formed by the extending portion 232 of the respective lens refracting or reflecting light, thereby optimizing an imaging performance of the lens module 10.

In an embodiment, referring to FIG. 1, the light-shielding plate 500 also abuts against the inner wall of the lens barrel 100 that defines the receiving cavity 120. In this way, the overall structure of the lens module 10 is more stable and reliable.

An embodiment of the present invention provides an electronic device including the above-mentioned lens module 10, and the electronic device has all the beneficial effects of the above-mentioned lens module 10, which will not be repeated here.

It should be noted that, the above are merely embodiments of the present invention, those skilled in the art can make improvements without departing from the inventive concept of the present invention, however, these improvements shall belong to the protection scope of the present invention.

What is claimed is:

1. A lens module, comprising:
a lens barrel, the lens barrel defining a light-through hole and a receiving cavity in communication with the light-through hole;
a lens group comprising at least two lenses stacked along a direction of a centerline of the light-through hole, wherein each of the at least two lenses comprises an optical portion and an extending portion surrounding the optical portion, and the extending portion comprises a connecting surface that abuts against and fits the lens barrel; and
a press ring comprising an upper ring surface and a lower ring surface that are opposite to each other in a direction parallel to the centerline of the light-through hole, and an outer wall surface connected to an outer ring edge of the upper ring surface and an outer ring edge of the lower ring surface, wherein the lens group and the press ring are sequentially arranged in the receiving cavity along a direction from the light-through hole towards the receiving cavity, the outer wall surface abuts against an inner wall of the lens barrel, and the upper ring surface abuts against the lens group,
wherein a leakage gap is defined between the lens barrel and the connecting surface of one of the at least two lenses that is adjacent to the press ring,
wherein an exhaust groove is provided on the upper ring surface, and the exhaust groove is in communication with the leakage gap.

2. The lens module as described in claim 1, wherein a plurality of exhaust grooves is provided.

3. The lens module as described in claim 2, wherein the plurality of exhaust grooves is evenly distributed on the upper ring surface around the centerline of the light-through hole.

4. The lens module as described in claim 1, wherein an extending direction of the exhaust groove is parallel to a radial direction of the light-through hole.

5. The lens module as described in claim 1, wherein the press ring further comprises an inner wall surface, the inner wall surface comprises a first ring surface and a second ring surface that are connected to each other, the first ring surface is connected to an inner ring edge of the upper ring surface, the second ring surface is connected to an inner ring edge of the lower ring surface, and an acute angle is formed between the first ring surface and the second ring surface.

6. The lens module as described in claim 1, wherein the optical portion comprises an object side surface and an image side surface that are opposite to each other, the extending portion further comprises a first extending surface and a second extending surface that are opposite to each other, the first extending surface extends from the object side surface in a direction facing away from an optical axis, the second extending surface extends from the image side surface in a direction facing away from the optical axis, and the connecting surface connects the first extending surface with the second extending surface; and
wherein the upper ring surface abuts against the second extending surface that is farthest from the light-through hole among second extending surfaces of extending portions of the at least two lenses.

7. The lens module as described in claim 6, wherein a gate slot is provided on the connecting surface, and the leakage gap comprises the gate slot.

8. The lens module as described in claim 6, further comprising a light-shielding plate located between two adjacent lenses of the at least two lenses and abutting against and fitting the two adjacent lenses.

9. The lens module as described in claim 8, wherein the light-shielding plate further abuts against and fits the lens barrel.

10. An electronic device, comprising the lens module as described in claim 1.
